(19) United States
(12) Patent Application Publication
(10) Pub. No.: US 2012/0208051 A1
(43) Pub. Date: Aug. 16, 2012

(54) ALKALINE SECONDARY BATTERY

(76) Inventors: Machiko Tsukiji, Osaka (JP); Fumiharu Sakashita, Osaka (JP); Masatoshi Hano, Osaka (JP); Fumlo Kato, Osaka (JP)

(21) Appl. No.: 13/502,499

(22) PCT Filed: Aug. 30, 2011
(86) PCT No.: PCT/JP2011/004833

§ 371 Date: Apr. 17, 2012

(30) Foreign Application Priority Data
Sep. 30, 2010 (JP) 2010-222402

(51) Int. Cl. H01M 2/12; H01M 10/24; H01M 2/08; H01M 10/42; H01M 2/02

(52) U.S. Cl. 429/56; 429/61

(57) ABSTRACT

An alkaline secondary battery of the present invention includes: a cylindrical battery case 1 which has a closed end and is provided with a positive electrode terminal 8; a cylindrical positive electrode 2 accommodated in the cylindrical battery case; a negative electrode 3 arranged in a hollow portion of the positive electrode; a separator 4 arranged between the positive electrode and the negative electrode; and an alkaline electrolyte solution accommodated in the cylindrical battery case, wherein a sealing body provided with a negative electrode terminal 9 hermetically seals an opening of the battery case, and the sealing body has a current cut-off mechanism configured to cut off current conduction between the negative electrode and the negative electrode terminal when internal pressure reaches a predetermined pressure P1.

### TECHNICAL FIELD

The present invention relates to alkaline secondary batteries.

### BACKGROUND ART

Alkaline dry batteries are primary batteries, and thus are discarded after use. However, for the sake of savings in resources, reuse of the alkaline dry batteries has been requested. Alkaline dry batteries after use can theoretically be charged for reuse, but various problems such as leakage and the like may arise when the alkaline dry batteries designed as primary batteries are charged as they are. For this reason, alkaline secondary batteries which have the same shape as dry batteries, but have devised active materials, devised internal structures, etc. are being developed (e.g., Patent Document 1).

### CITATION LIST

### Patent Document

PATENT DOCUMENT 1: Japanese Translation of PCT International Application No. H08-508847
PATENT DOCUMENT 2: Japanese Patent Publication No. 2001-60454
PATENT DOCUMENT 3: Japanese Patent Publication No. 2005-294046

### SUMMARY OF THE INVENTION

### Technical Problem

However, when such an alkaline secondary battery is overcharged, or is repeatedly charged/discharged many cycles, gas is generated and accumulated in the battery. When battery internal pressure exceeds a predetermined pressure, an explosion-proof valve operates to prevent the battery from being exploded. Thus, from a part at which the valve is ruptured and a gas outlet, an alkaline electrolyte solution may leak outside the battery.

In particular, in an existing inside-out type alkaline dry battery (a negative electrode is provided inside a positive electrode), an active material is packed as large an amount as possible in a certain space in order to increase battery capacity. When such a configuration is applied to the alkaline secondary battery, space for accumulating gas is very small. Thus, accumulation of only a small amount of gas increases internal pressure, which leads to leakage. The leakage is more likely to occur particularly when the alkaline secondary battery is overcharged, or when a cumulative amount of generated gas increases at the ending of cycles. When the leakage occurs, the alkaline electrolyte solution enters an electronic device in which the alkaline secondary battery is accommodated, so that the electronic device itself may short out or may be broken due to corrosion.

In view of the foregoing, the present invention was devised. It is an objective of the present invention to provide an alkaline secondary battery, wherein even when gas is generated in the battery, further generation of the gas is inhibited by stopping charging/discharging the battery before leakage occurs.

### Solution to the Problem

An alkaline secondary battery of the present application includes: a cylindrical battery case which has a closed end and is provided with a positive electrode terminal; a cylindrical positive electrode accommodated in the cylindrical battery case; a negative electrode arranged in a hollow portion of the positive electrode; a separator arranged between the positive electrode and the negative electrode; and an alkaline electrolyte solution accommodated in the cylindrical battery case, wherein a sealing body provided with a negative electrode terminal hermetically seals an opening of the battery case, and the sealing body has a current cut-off mechanism configured to cut off current conduction between the negative electrode and the negative electrode terminal when internal pressure reaches a predetermined pressure P1. A negative electrode active material may be zinc, a hydrogen-storing alloy, metal magnesium, etc.

In a preferable embodiment, a negative electrode current collector configured to supply a current to the negative electrode terminal is arranged in the negative electrode, the current cut-off mechanism includes a first connection member which is made of metal and is electrically connected to the negative electrode terminal, and a second connection member which is made of metal and is electrically connected to the negative electrode current collector, the first connection member is electrically connected to the second connection member, and when the internal pressure reaches the predetermined pressure P1, the second connection member is ruptured by the internal pressure to cut off current conduction between the negative electrode current collector and the negative electrode terminal.

The negative electrode may contain zinc or a zinc alloy as a main active material, and the first connection member and the second connection member may be made of copper or an alloy containing copper as a main component.

The alkaline secondary battery preferably further includes a communicative connection mechanism configured to bring space in the battery into communication with space outside the battery when the internal pressure reaches a predetermined pressure P2, where P1<P2.

When the alkaline secondary battery is an AA size alkaline secondary battery, the predetermined pressures P1 [MPa] and P2 [MPa] may satisfy the relational expressions: 2.0≦P1, P2≦8.0, and P2−P1≧3.5.

When the alkaline secondary battery is an AAA size alkaline secondary battery, the predetermined pressures P1 [MPa] and P2 [MPa] may satisfy the relational expressions: 3.0≦P1, P2≦11.0, and P2−P1≧6.0.

When the alkaline secondary battery is a D size alkaline secondary battery, the predetermined pressures P1 [MPa] and P2 [MPa] may satisfy the relational expressions: 0.5≦P1, P2≦2.0, and P2−P1≧1.0.

When the alkaline secondary battery is a C size alkaline secondary battery, the predetermined pressures P1 [MPa] and P2 [MPa] may satisfy the relational expressions: 1.0≦P1, P2≦3.0, and P2−P1≧1.0.

In a preferable embodiment, the first connection member may include a thin portion having a smaller thickness than a portion around the thin portion, and the communicative connection mechanism may be operated by rupturing the thin portion by the internal pressure. The positive electrode terminal may include a return-type rubber valve body or a spring valve body, and the communicative connection mechanism may be operated by operation of the rubber valve body or the spring valve body.

The second connection member may have a thickness of 0.1 mm to 0.7 mm, both inclusive.

A water repellant may be applied to at least part of surfaces of the first connection member, the second connection member, or an electrical conduction mediating member which face the negative electrode.

The negative electrode may be a gelled zinc negative electrode obtained by dispersing zinc particles or zinc alloy particles into a gelled alkaline electrolyte solution. Alternatively, a porous body made of zinc or a zinc alloy may be used as the negative electrode.

Nonwoven fabric may be provided between the negative electrode and the second connection member to insulate the negative electrode from the second connection member.

The positive electrode may contain manganese dioxide as a main active material. Metatitanic acid may be added to the positive electrode in a mass ratio of 0.1% to 3%, both inclusive relative to the manganese dioxide. When the manganese dioxide has a theoretical capacity of 308 mAh/g, and the zinc has a theoretical capacity of 819 mAh/g, a value of negative electrode theoretical capacity/positive electrode theoretical capacity may be greater than or equal to 1.10 and less than or equal to 1.30.

The alkaline secondary battery may be an AA size alkaline secondary battery, a volume of space in the battery formed when the battery case is sealed with the sealing body may be larger than 6.15 mL, a weight of the manganese dioxide contained in the positive electrode may be greater than or equal to 8.0 g and less than or equal to 9.0 g, a weight of the zinc contained in the negative electrode may be greater than or equal to 3.0 g and less than or equal to 4.0 g, and a total amount of the alkaline electrolyte solution may be greater than or equal to 3.5 g and less than or equal to 4.0 g.

### Advantages of the Invention

An alkaline secondary battery of the present invention can no longer be charged/discharged when internal pressure reaches a predetermined pressure P1, and thus further generation of gas is prevented, and it is noticed to a user that the battery has to be changed, thereby preventing leakage in a device.

### BRIEF DESCRIPTION OF THE DRAWINGS

FIG. 1 is a partial cross-sectional view illustrating an alkaline secondary battery of a first embodiment.

FIG. 2 is a partial cross-sectional view illustrating an alkaline secondary battery of a second embodiment.

FIG. 3 is a partial cross-sectional view illustrating an alkaline secondary battery of a third embodiment.

FIG. 4 is g graph illustrating the result of evaluation of a first example.

FIG. 5 is a view illustrating a device for evaluation of a third example.

FIG. 6 is a partial cross-sectional view of an alkaline secondary battery of a fifth example.

FIG. 7 is a graph illustrating the result of evaluation of a sixth example.

FIG. 8 is a partial cross-sectional view illustrating an alkaline secondary battery of other embodiments.

FIG. 9 is a partial cross-sectional view illustrating another alkaline secondary battery of the other embodiments.

FIG. 10 is a partial cross-sectional view illustrating still another alkaline secondary battery of the other embodiments.

FIG. 11 is a partial cross-sectional view illustrating an alkaline dry battery.

### DESCRIPTION OF EMBODIMENTS

### Definitions

Saying that a negative electrode includes zinc or a zinc alloy as a main active material means that the proportion of zinc or a zinc alloy to an active material of the negative electrode is 50% or more by mass.

An alloy containing copper as a main component means an alloy in which the proportion of copper is 50% or more by mass.

Saying that a positive electrode includes manganese dioxide as a main active material means that the proportion of manganese dioxide to an active material of the positive electrode is 50% or more by mass.

Nonwoven fabric isolating a negative electrode from a connection member means a component configured as a boundary surface which halves space sandwiched between the negative electrode and the connection member to form space close to the negative electrode and space close to the connection member.

A size D means LR20 defined for alkaline dry batteries in IEC60086, and is denoted by D in the USA.

A size C means LR14 defined for alkaline dry batteries in IEC60086, and is denoted by C in the USA.

A size AA means LR6 defined for alkaline dry batteries in IEC60086, and is denoted by AA in the USA.

A size AAA means LR03 defined for alkaline dry batteries in IEC60086, and is denoted by AAA in the USA.

(How the Present Invention was Achieved)

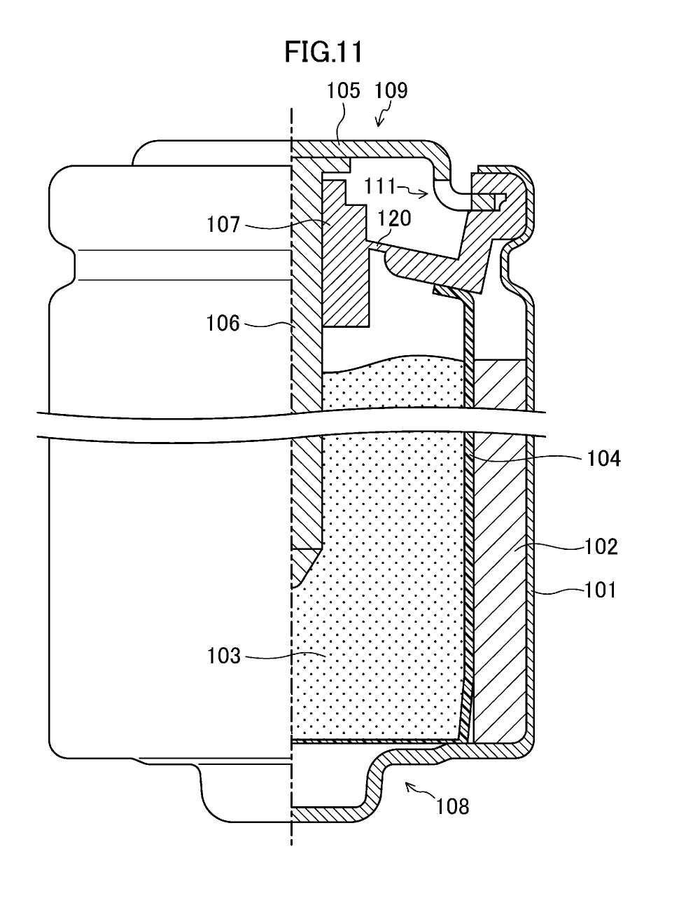

FIG. 11 is a partial cross-sectional view illustrating an example alkaline dry battery. A cylindrical positive electrode 102 is inserted in a cylindrical battery case 101 having a closed end and made of metal so that the cylindrical positive electrode 102 is in intimate contact with an inner wall of the cylindrical battery case 101. A separator 104 is arranged on an inner wall of the positive electrode 102, and a negative electrode 103 is put inside the separator 104. A bottom of the battery case 101 outwardly protrudes to form a positive electrode terminal 108. The positive electrode 102 is formed by mixing a small amount of graphite with electrolytic manganese dioxide as a positive electrode mixture. The negative electrode 103 is formed by dispersing zinc alloy powder in gel, with which a potassium hydroxide aqueous solution as an alkaline electrolyte solution is mixed. Moreover, the positive electrode 102 and the separator 104 are also impregnated with the alkaline electrolyte solution. A nail-shaped negative electrode current collector 106 is inserted into a center portion of the negative electrode 103. An upper portion of the negative electrode current collector 106 protrudes from the negative electrode 103. A sealing resin member 107 is arranged around the portion of the negative electrode current collector 106 which protrudes from the negative electrode 103. Above the sealing resin member 107, a negative electrode terminal plate 105 is placed, and is electrically connected to the negative electrode current collector 106. An opening end of the battery case 101 is crimped via an outer peripheral edge of the sealing resin member 107 onto a rim of the negative electrode terminal plate 105, thereby sealing the battery. Note that an outer surface of the negative electrode terminal plate 105 serves as a negative electrode terminal 109.

The alkaline dry battery illustrated in FIG. 11 can be charged, and thus can also be used as an alkaline secondary battery in theory. When the battery is discharged, charged, or in storage, gas such as hydrogen may be generated from the negative electrode 103 due to corrosion of zinc serving as a negative electrode active material. When a predetermined pressure is created in the battery due to the gas, a thin portion 120 of the sealing resin member 107 is ruptured, and the gas in the battery is released outside the battery from a gas outlet 111 provided in the negative electrode terminal plate 105. In this way, the battery is prevented from being ruptured due to the gas generated therein. However, this is a structure in case of an emergency, and enough gas to rupture the thin portion 120 is not generated in normal storage and discharge.

However, gas may also be generated in charging alkaline secondary batteries, and the alkaline secondary batteries are charged/discharged several cycles so that the alkaline secondary batteries are used for a period more than several times as long as a period in which alkaline dry batteries are used. Thus, a large amount of gas may be generated in use of the alkaline secondary batteries compared to the alkaline dry batteries. Therefore, when the alkaline secondary batteries are used only once as dry batteries, release of gas generated in the batteries to the outside (and release of the electrolyte together with the gas to the outside) rarely occurs, but when the alkaline secondary batteries are charged/discharged several cycles as secondary batteries, the gas in the batteries having this structure is more likely to be released to the outside. That is, when normal alkaline dry batteries are used without modification as secondary batteries, leakage is more likely to occur compared to the case where the normal alkaline dry batteries are used as dry batteries. In particular, in recent years, a large amount of a negative electrode active material has been packed in order to increase battery capacity. Thus, space for accumulating gas is smaller than it was before. For this reason, even when the amount of gas generated is small, internal pressure increases, so that there is an increased possibility that the gas is released outside and leakage occurs.

For this reason, the inventors of the present application have studied several methods for preventing the occurrence of leakage of alkaline secondary batteries. For example, Patent Documents 2, 3 describe mechanisms used for nickel-hydrogen secondary batteries, etc. to stop charging/discharging when internal pressure increases. However, alkaline electrolyte solutions used for alkaline secondary batteries have a good wetting property compared to other electrolytes of secondary batteries, reducing leakage of the alkaline electrolyte solutions to the outside is difficult, and materials which can be used as the alkaline electrolyte solutions are limited. Thus, the configurations of Patent Documents 2, 3 cannot be simply used without modification. Based on the foregoing, the present inventors have conducted various experiments and studies, and arrived at the present invention.

Embodiments of the present invention will be described in detail below with reference to the drawings. In the drawings below, for the sake of simplicity, components having substantially the same function are labeled with the same reference numbers.

### First Embodiment

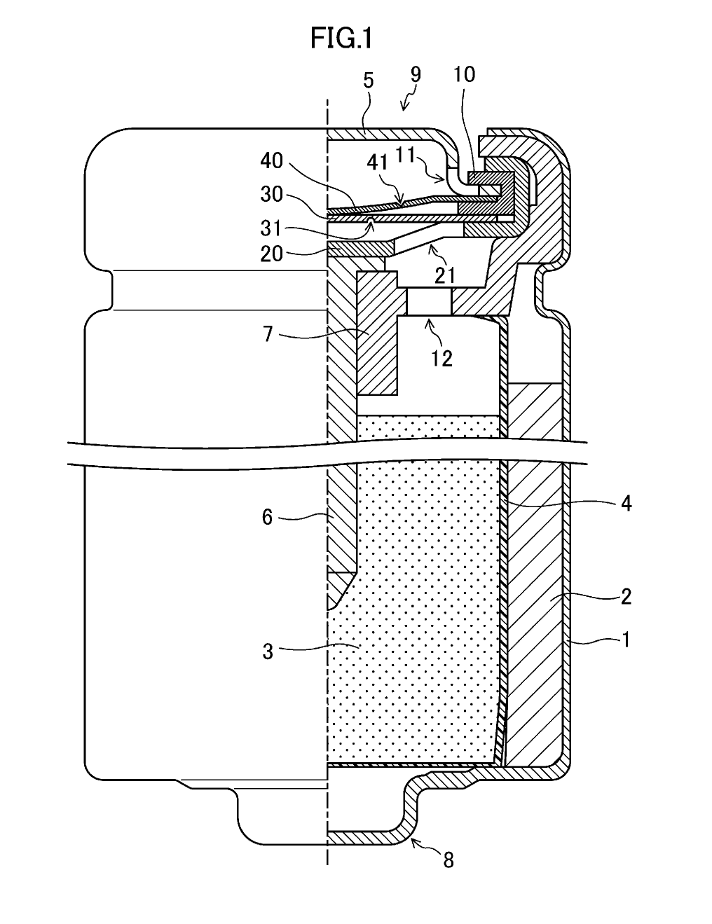

A structure of an alkaline secondary battery according to a first embodiment is illustrated in FIG. 1. The alkaline secondary battery of the present embodiment includes a cylindrical battery case 1 having a closed end. The cylindrical battery case 1 accommodates a cylindrical positive electrode 2, a negative electrode 3 arranged in a hollow portion of the positive electrode 2, a separator 4 arranged between the positive electrode 2 and the negative electrode 3, and an alkaline electrolyte solution which saturates the positive electrode 2, the negative electrode 3, and the separator 4. An outwardly protruding positive electrode terminal 8 is provided on a bottom of the battery case 1. A nail-shaped negative electrode current collector 6 is arranged on a center axis of the battery case 1. A lower portion (most of a body portion) of the negative electrode current collector 6 is inserted in the negative electrode 3.

The positive electrode 2 is formed by mixing a conductive material such as carbon powder with manganese dioxide as an active material, and shaping the obtained mixture into a cylindrical form. The negative electrode 3 is a gelled negative electrode formed by dispersing zinc powder or zinc alloy powder into gel, with which the alkaline electrolyte solution is mixed. The alkaline electrolyte solution is a strongly alkaline aqueous solution such as a potassium hydroxide aqueous solution or an aqueous sodium hydroxide. The separator 4 has insulating properties and water-pervious properties, and is made of, for example, nonwoven fabric, a porous resin film, or a combination of these materials.

The negative electrode current collector 6 is surrounded, at directly below its head portion, by a sealing resin member 7 made of resin. The sealing resin member 7 extends to the battery case 1, and has a disk-like shape. A first vent hole 12 is formed in the sealing resin member 7 in such a way that the first vent hole 12 penetrates the sealing resin member 7 from top to bottom.

A disk-like electrical conduction mediating member 20 made of metal is welded to the head portion of the negative electrode current collector 6, and covers an opening of the battery case 1. Moreover, a second vent hole 21 is also formed in the electrical conduction mediating member 20 in such a way that the second vent hole 21 penetrates the electrical conduction mediating member 20 from top to bottom. A center portion of the electrical conduction mediating member 20 is welded to the negative electrode current collector 6, and the electrical conduction mediating member 20 rises from its welding portion toward its outer edge, that is, the electrical conduction mediating member 20 has a shape having a recessed center portion.

A second connection member 30 which is a circular thin plate made of metal is provided on a top end portion (outer edge portion) of the electrical conduction mediating member 20. The electrical conduction mediating member 20 and the second connection member 30 are strongly pressed against each other by later-described crimping by a pressing member 10 to ensure electrical connection. The second connection member 30 includes a circumferential engraved portion 31 provided around the center axis of the battery case 1. The engraved portion 31 has a smaller thickness than a portion therearound due to engraving.

A first connection member 40 which is a circular thin plate made of metal is arranged on the second connection member 30. A center portion of the first connection member 40 is electrically connected and fixed to the second connection member 30 by welding, or the like, inside the circumference of the engraved portion 31 of the second connection member 30. The first connection member 40 includes a thin portion 41 formed in a portion outside the fixed portion, wherein the thin portion 41 has a smaller thickness than a portion therearound due to engraving. The pressing member 10 having insulating properties is interposed between an outer peripheral portion of the first connection member 40 and the second connection member 30, so that the outer peripheral portion is electrically insulated. The peripheral portion of the first connection member 40 is located at a higher position than the center portion of the first connection member 40 by the thickness of the pressing member 10, and the center portion of the first connection member 40 is fixed, at its lower part, to the second connection member 30. Thus, upward force as stress is accumulated on the first connection member 40 as a whole. That is, the first connection member 40 serves as an elastic member (plate spring in the present embodiment).

On the first connection member 40, a negative electrode terminal plate 5 having a hat shape and made of metal is arranged with its raised side facing upward. The hat shape in the present embodiment means a shape in which a flange (brim of a hat) is arranged outwardly from a side surface outer edge of a Petri dish. A flange portion of an outer peripheral portion of the negative electrode terminal plate 5 is placed on the first connection member 40, and the flange portion and the first connection member 40 are pinched and pressed against each other by the pressing member 10, thereby ensuring electrical connection. The pressing member 10 is a thin ring plate made of insulating resin, and is bent along a circumferential direction to have a U-shaped cross section to pinch the negative electrode terminal plate 5 and the first connection member 40. A through hole 11 is formed at a base of the flange portion of the negative electrode terminal plate 5.

An upper end of the battery case 1, the sealing resin member 7, the electrical conduction mediating member 20, the second connection member 30, the first connection member 40, the pressing member 10, and the negative electrode terminal plate 5 are crimped, thereby hermetically sealing the battery. The sealing resin member 7, the electrical conduction mediating member 20, the second connection member 30, the first connection member 40, the pressing member 10, and the negative electrode terminal plate 5 form a sealing body.

In the alkaline secondary battery of the present embodiment having the above-described structure, when gas such as hydrogen is generated due to charge/discharge or during storage, the gas accumulates in space above the negative electrode 3. The space is in communication with the first vent hole 12 and the second vent hole 21, but is shielded by the second connection member 30 from space above the second connection member 30. When the amount of the generated gas increases, pressure in the space above the negative electrode 3 (internal pressure of the battery) increases.

When the internal pressure of the battery reaches a predetermined pressure P1, the engraved portion 31 of the second connection member 30 is ruptured, which upwardly moves the first connection member 40 due to spring force which has been accumulated, so that electrical conduction between the first connection member 40 and the second connection member 30 is cut off. Thus, current conduction is cut off on the way from the negative electrode 3 to the negative electrode terminal 9. P1 is a pressure much lower than battery internal pressure at which the alkaline secondary battery is ruptured.

Such a current cut-off mechanism including the first connection member 40 and the second connection member 30 cuts off the current conduction in the battery before the internal pressure reaches a high pressure at which the battery itself is ruptured. Therefore, for example, when gas is generated in charging a battery, the charging can be stopped to prevent further generation of the gas, and thus safety is provided. Since a large amount of gas is generated particularly when overcharge occurs, the current cut-off mechanism of the present embodiment is effective as a safety measure against the overcharge. Moreover, a large amount of gas may also be generated when the number of charge/discharge cycles is increased. Thus, also in this case, the current cut-off mechanism is effective as a safety measure. A user notices that the battery can no longer be charged/discharged, understands that the battery is no longer usable, and changes the battery.

Moreover, even when the engraved portion 31 of the second connection member 30 is ruptured, the alkaline secondary battery of the present embodiment is hermetically sealed by the first connection member 40. Thus, release of the alkaline electrolyte solution to the outside of the battery, that is, leakage after cutting off the current can be prevented.

Moreover, after the current cut-off mechanism has cut off the current conduction in the battery, even when the internal pressure of the battery is further increased due to corrosion of zinc of the negative electrode, the thin portion 41 of the first connection member 40 is ruptured when the battery internal pressure reaches a predetermined pressure P2, so that gas in the battery is released from the ruptured portion of the thin portion 41 through the through hole 11 to the outside of the battery. Here, P2 is a pressure which is higher than P1, and is lower than the battery internal pressure at which the alkaline secondary battery is ruptured. The alkaline secondary battery of the present embodiment includes a communicative connection mechanism configured to bring space in the battery into communication with space outside the battery by rupturing the thin portion 41 as described above. Thus, even when the battery is left standing after the current conduction in the battery has been cut off, the alkaline secondary battery is not ruptured, and thus safety is provided. In particular, when the current cut-off mechanism stops charging/discharging, this indicates to a user that the battery has to be changed. If the user notices the indication, and changes the battery at an earlier stage, gas is released from the battery outside an electronic device even when the communicative connection mechanism operates. Thus, leakage in the electronic device can be prevented.

The electrical conduction mediating member 20, the first connection member 40, and the second connection member 30 are preferably made of, in particular, copper or an alloy containing copper as a main component. This is because alkaline secondary batteries are different from nickel-hydrogen batteries, lithium ion secondary batteries, etc. in that an electrolyte of the alkaline secondary batteries generates hydrogen gas when the electrolyte adheres to metals other than copper and the alloy containing copper as a main component during electrical conduction.

### Second Embodiment

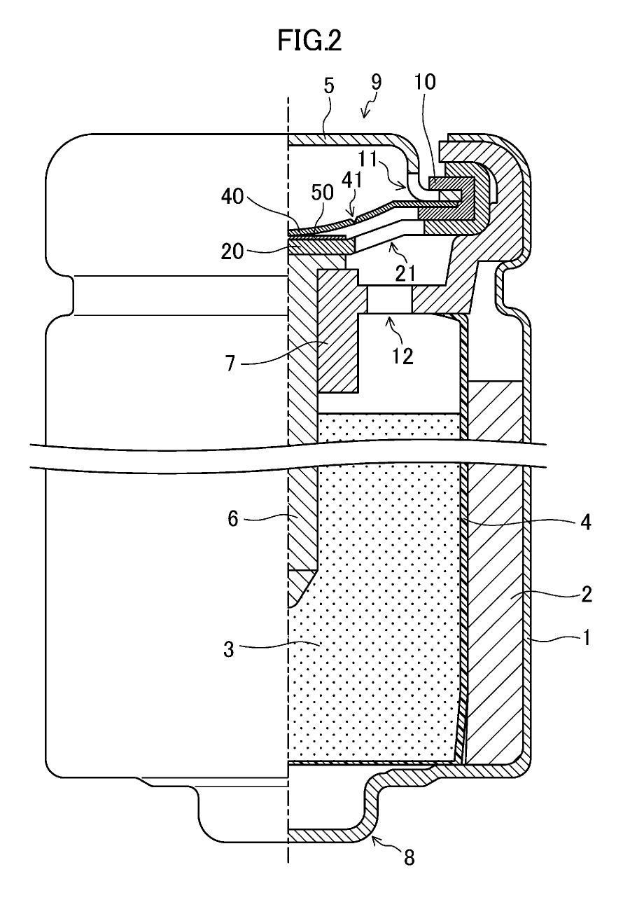

A partial cross-sectional view of an alkaline secondary battery according to a second embodiment is illustrated in FIG. 2. The present embodiment is substantially the same as the first embodiment except a second connection member 50. The difference from the first embodiment will be described below.

The second connection member 50 of the present embodiment is made of circular metal foil, and is spot welded to a recessed bottom portion (center portion) of the electrical conduction mediating member 20. The second connection member 50 is also spot welded to a center portion of the first connection member 40. The second connection member 50 has such a size that does not close the second vent hole 21.

In the present embodiment, space for accumulating gas generated in the battery is shielded by the first connection member 40 from space above the first connection member 40. When the internal pressure of the battery increases, force by which the first connection member 40 upwardly pulls the second connection member 50 made of the metal foil increases. When battery internal pressure reaches a predetermined pressure P1, a boundary between the spot welded portion and the other portions can no longer withstand the upwardly pulling force, so that the second connection member 50 is ruptured. Thus, the first connection member 40 upwardly moves due to spring force which has been accumulated, thereby cutting off electrical conduction between the first connection member 40 and the second connection member 50.

The present embodiment produces the same advantages as those of the first embodiment. Moreover, the present embodiment is simpler in structure and lower in manufacturing cost than the first embodiment.

### Third Embodiment

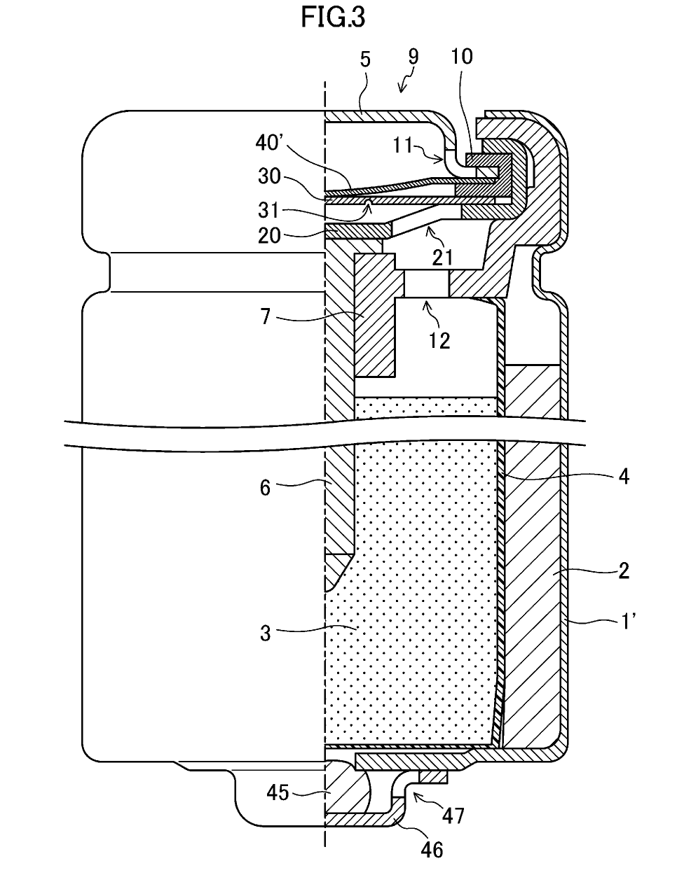

A partial cross-sectional view of an alkaline secondary battery according to a third embodiment is illustrated in FIG. 3. The present embodiment is substantially the same as the first embodiment except that a first connection member 40′ includes no thin portion, and a return-type rubber valve body 45 is provided on a side close to the positive electrode 8. The difference form the first embodiment will be described below.

A current cut-off mechanism of the present embodiment is the same as that of the first embodiment, but a communicative connection mechanism of the present embodiment is different from that of the first embodiment. The communicative connection mechanism of the present embodiment is provided on the side close to the positive electrode 8. A hole is formed in a center portion of a bottom of a battery case V. The hole is closed with the rubber valve body 45. The rubber valve body 45 is made of rubber, and has a substantially disc shape. Moreover, a hat-like positive electrode terminal plate 46 is put to cover the entirety of the rubber valve body 45, and a flange portion of the positive electrode terminal plate 46 is electrically connected and fixed to the battery case 1′ by welding, etc. A through hole 47 is formed in a side surface of the hat-like positive electrode terminal plate 46.

In the present embodiment, after operation of the current cut-off mechanism, when the internal pressure of the battery further increases to P2, the rubber valve body 45 deforms, thereby forming a partial gap between the rubber valve body and the battery case 1′. Space inside the battery is brought into communication with space outside the battery via the gap and the through hole 47. Thus, gas in the battery can be released from the gap through the through hole 47 to the outside of the battery, which can reduce battery internal pressure to less than P2. When the battery internal pressure is reduced to less than P2, the gap between the rubber valve body 45 and the battery case 1′ disappears.

The present embodiment produces the same advantages as those of the first embodiment.

### EXAMPLES

### First Example

AA size alkaline secondary batteries were formed according to the following procedure. Note that a battery formed to have the structure illustrated in the first embodiment is referred to as Battery A0, and a battery formed to have the structure illustrated in the second embodiment is referred to as Battery B0.

First, a positive electrode 2 was formed.

Electrolytic manganese dioxide and graphite were mixed in a mass ratio of 94:6 to obtain mixed powder. To 100 percent by mass of the mixed powder, 2 percent by mass of an alkaline electrolyte solution was added. The obtained mixture was stirred in a mixer so that the mixed powder and the alkaline electrolyte solution were uniformly mixed, and was sized into a certain particle size. The alkaline electrolyte solution was an aqueous solution containing 35% by mass of potassium hydroxide (containing 1% by mass of ZnO).

The sized mixed powder was press-molded by using a hollow cylinder mold. The positive electrode 2 (positive electrode mixture pellet) was thus obtained. Here, as the electrolytic manganese dioxide, HH-TF manufactured by Tosoh Corporation was used, and as the graphite, SP-20 manufactured by Nippon Graphite Industries, Ltd. was used.

In each of cylindrical battery cases 1 having a closed end, multiple ones of the positive electrode mixture pellet were inserted, and pressed so that the positive electrode mixture pellets were brought into intimate contact with an inner surface of the battery case 1, thereby obtaining the positive electrode 2.

Then, a separator 4 was formed.

Nonwoven fabric made of vinylon-lyocell composite fiber manufactured by Kuraray Co., Ltd. and cellophane manufactured by Futamura Chemical Co., Ltd. were put on top of each other, and were rolled into a cylinder form. To one end of the obtained cylinder form, a stack of nonwoven fabric and cellophane was also adhered as a bottom portion by a hot-melt adhesive, thereby obtaining the separator 4. The separator 4 was inserted into a hollow portion inside each positive electrode 2 with the bottom portion facing downward. After that, the alkaline electrolyte solution was poured to wet the separator 4 and the positive electrode mixture pellets.

Subsequently, a negative electrode 3 was formed.

First, zinc alloy powder containing 0.005% by mass of Al, 0.015% by mass of Bi, and 0.02% by mass of In was produced in a gas atomization process. Then, the produced zinc alloy powder was classified by using a sieve. The zinc alloy powder was adjusted to have a BET specific surface area of 0.040 cm²/g.

Then, to 100 percent by mass of the zinc alloy powder, 50 percent by mass of an alkaline electrolyte solution, 0.35 percent by mass of cross-linked polyacrylic acid, and 0.7 percent by mass of cross-linked sodium polyacrylate were mixed as a gelled alkaline electrolyte solution serving as a dispersion medium, thereby obtaining a gelled electrolyte. The zinc alloy powder and the gelled alkaline electrolyte solution were mixed to obtain a gelled negative electrode, which was poured into a hollow portion of each separator 4.

Then, the sealing body illustrated in the first embodiment and the sealing body illustrated in the second embodiment were prepared. The sealing bodies were each provided with a negative electrode current collector 6. A first connection member 40 of each sealing body was made of a copper plate having a thickness of 0.2 mm. A second connection member 30 of the sealing body illustrated in the first embodiment was made of a copper plate having a thickness of 0.2 mm. For each sealing body, by setting P1=3.5 MPa, the thickness of an engraved portion 31 and the thickness of a second connection member 50 made of copper foil were adjusted. Moreover, by setting P2=7.0 MPa, the thickness of a thin portion 41 was adjusted. These sealing bodies were inserted into openings of the battery cases 1, respectively, and crimped to achieve hermetic sealing. Batteries A0, B0 of the present example were thus formed.

For comparison purposes, a commercially available alkaline secondary battery (manufactured by Pure Energy Solutions., Inc.) was used as Battery Y of a comparative example, and a commercially available alkaline dry battery (manufactured by Panasonic Corporation) was used as Battery Z of the comparative example.

A method for evaluating the batteries is as follows.

The evaluation was performed in such a manner that the batteries were repeatedly subjected to discharge/charge and high temperature storage in combination, and were observed for the occurrence of leakage. The batteries were continuously discharged at 100 mA, and when the voltage of the batteries reached 1.0 V, the discharge was ended. After the discharge, the batteries were charged at a constant current of 150 mA, and then at a constant voltage of 1.8 V. When the current value reached 25 mA, the charge was ended. After the charge, the batteries were stored at 60° C. for one day. This was regarded as one cycle.

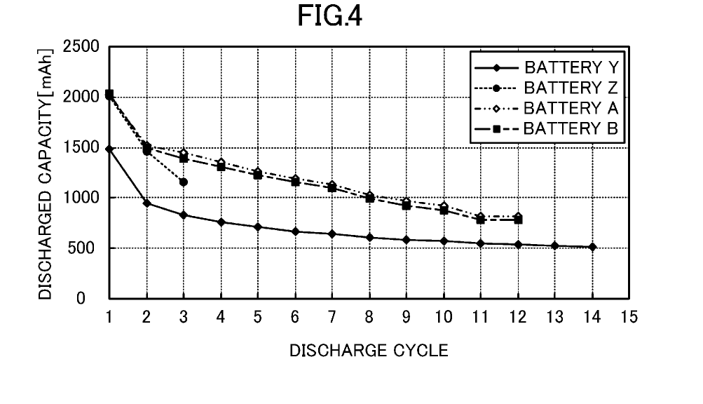

FIG. 4 is a view illustrating discharge capacity in discharging the batteries in each cycle. First, the discharge capacity of the commercially available alkaline secondary battery (Battery Y) was reduced to 1000 mAh or lower due to charge in the first cycle, and thus the capacity was low. Moreover, since Battery Y was not provided with a current cut-off mechanism, leakage occurred in the 14th cycle. The reason way the capacity was low seems to be because the amount of an active material was reduced to ensure certain width of space for accumulating gas in order to increase the number of charge/discharge cycles without providing a current cut-off mechanism.

The commercially available alkaline dry battery (Battery Z) had a sufficient capacity, but leakage occurred after charging the battery three times.

The capacities of both Batteries A0, B0 of the present example were gradually reduced as the number of cycles increased. However, in the first and second cycles, Batteries A0, B0 each had a capacity comparable to that of an alkaline dry battery. In the 12th cycle, the current cut-off mechanisms operated, so that charge/discharge was no longer possible, but no leakage occurred. This indicates to a user that Batteries A0, B0 can no longer be used, thereby encouraging the user to change the batteries. Thus, the batteries may be discarded before leakage occurs.

### Second Example

In a second example, the levels of P1 and P2 were considered.

<<AA Size>>

The thicknesses of the engraved portion 31 and the thin portion 41 of Battery A0 of the first example were varied to form Batteries A1-A9 in which the levels of P1 and P2 were adjusted. Moreover, Battery C1 having the configuration of the third embodiment was formed by using materials, a specification, and a method similar to those of the first example. In Battery C1, the thickness of the engraved portion 31 was adjusted by setting P1=2.0 MPa, and materials and the thickness of the rubber valve body 45 were adjusted by setting P2=7.0 MPa.

The batteries were evaluated in the following three tests: (1) the batteries were subjected to cycles the same as those of the first example, and in which number of cycle the current cut-off mechanisms (CIDs) operated was checked, (2) the batteries in which the current cut-off mechanisms operated were stored at 60° C. for four days, and were checked for the occurrence of leakage; and (3) the batteries in which no leakage occurred in test (2) were stored at 80° C. for one month, and were checked for the occurrence of ruptures. In each test, five batteries for which each of specifications of P1, P2 was the same were used. The result of evaluation is shown in Table 1.

TABLE 1

| | | | Result of Evaluation | | |
|---|---|---|---|---|---|
| | | | The Number of | The Number of | |
| | | | Batteries | Batteries | |
| | | | in which | in which | The Number |
| Battery | | | CIDs Operated | Leakage Occurred | of Ruptured |
| | P1 | P2 | within 4 Cycles | within 4 Days | Batteries |
| | [MPa] | [MPa] | in Test (1) | in Test (2) | in Test (3) |
| A1 | 1.0 | 7.0 | 2 | 0 | 0 |
| A2 | | 8.0 | 2 | 0 | 0 |
| A3 | | 9.0 | 1 | 0 | 1 |
| A4 | 2.0 | 7.0 | 0 | 0 | 0 |
| A5 | | 8.0 | 0 | 0 | 0 |
| A6 | | 9.0 | 0 | 0 | 2 |
| A7 | 4.5 | 7.0 | 0 | 3 | 0 |
| A8 | | 8.0 | 0 | 0 | 0 |
| A9 | | 9.0 | 0 | 0 | 1 |
| C1 | 2.0 | 7.0 | 0 | 0 | 0 |

Secondary batteries are preferably capable of withstanding five or more charge/discharge cycles. Therefore, in test (1), the number of batteries in which the current cut-off mechanisms operated before the fifth cycle is shown in Table 1. When P1 was set to 2.0 MPa or higher, the number of batteries in which the current cut-off mechanisms operated before the fifth cycle was 0, and thus it can be said that batteries in which P1 is set to 2.0 MPa or higher have practically sufficient properties.

In test (2), the storage at 60° C. for 4 days is considered to be comparable to storage at ambient temperature for about a half year, and thus no leakage preferably occurs during this period of time. In Battery A7 in which P2−P1 was 2.5 MPa, leakage occurred in three of the five batteries, but no leakage occurred in the other batteries in which P2−P1 was 3.5 MPa or more. That is, when P2−P1 is 3.5 MPa or more, a period from the time the current cut-off mechanism operates to bring the battery in an unusable state to the time the communicative connection mechanism operates due to battery internal pressure further increased by corrosion of zinc in the negative electrode is a half year or longer. Thus, in this length of period, a user probably notices that the battery is unusable, so that the battery is changed to avoid leakage in an electronic device.

In test (3), when P2 was set to 8.0 MPa, no batteries were ruptured. However, when P2 was set to 9.0 MPa, there were ruptured batteries. Thus, P2 is preferably set to 8.0 MPa or lower.

<<AAA Size>>

AAA size Alkaline Secondary Batteries A10-A18 (structure of the first embodiment) and AAA size Alkaline Secondary Batteries C2 (structure of the third embodiment) were formed and evaluated in a manner similar to that of the AA size batteries described above. The result of the evaluation is shown in Table 2.

TABLE 2

| | | | Result of Evaluation | | |
|---|---|---|---|---|---|
| | | | The Number of | The Number of | |
| | | | Batteries | Batteries in | |
| | | | in which | which Leakage | The Number |
| Battery | | | CIDs Operated | Occurred | of Ruptured |
| | P1 | P2 | within 4 cycles | within 4 days | Batteries |
| | [MPa] | [MPa] | in Test (1) | in Test (2) | in Test (3) |
| A10 | 2.0 | 10.0 | 3 | 0 | 0 |
| A11 | | 11.0 | 2 | 0 | 0 |
| A12 | | 12.0 | 3 | 0 | 2 |
| A13 | 3.0 | 10.0 | 0 | 0 | 0 |
| A14 | | 11.0 | 0 | 0 | 0 |
| A15 | | 12.0 | 0 | 0 | 2 |
| A16 | 5.0 | 10.0 | 0 | 3 | 0 |
| A17 | | 11.0 | 0 | 0 | 0 |
| A18 | | 12.0 | 0 | 0 | 2 |
| C2 | 2.0 | 10.0 | 0 | 0 | 0 |

It can be seen that it is preferable in the AAA size alkaline secondary batteries that P1≧3.0 MPa, P2−P1≧6.0 MPa, and P2≦11.0 MPa.

<<D Size>>

D size Alkaline Secondary Batteries A19-A27 (structure of the first embodiment) and D size Alkaline Secondary Battery C3 (structure of the third embodiment) were formed and evaluated in a manner similar to that of the AA size batteries described above. The result of the evaluation is shown in Table 3.

TABLE 3

| | | | Result of Evaluation | | |
|---|---|---|---|---|---|
| | | | The Number of | The Number of | |
| | | | Batteries | Batteries in | |
| | | | in which | which Leakage | The Number |
| Battery | | | CIDs Operated | Occurred | of Ruptured |
| | P1 | P2 | within 4 cycles | within 4 Days | Batteries |
| | [MPa] | [MPa] | in Test (1) | in Test (2) | in Test (3) |
| A19 | 0.3 | 1.5 | 2 | 0 | 0 |
| A20 | | 2.0 | 1 | 0 | 0 |
| A21 | | 2.5 | 1 | 0 | 2 |
| A22 | 0.5 | 1.5 | 0 | 0 | 0 |
| A23 | | 2.0 | 0 | 0 | 0 |
| A24 | | 2.5 | 0 | 0 | 2 |
| A25 | 1.0 | 1.5 | 0 | 1 | 0 |
| A26 | | 2.0 | 0 | 0 | 0 |
| A27 | | 2.5 | 0 | 0 | 2 |
| C3 | 0.5 | 2.0 | 0 | 0 | 0 |

It can be seen that it is preferable in the D size alkaline secondary batteries that P1≧0.5 MPa, P2−P1≧1.0 MPa, and P2≦2.0 MPa.

<<C Size>>

C size Alkaline Secondary Batteries A28-A36 (structure of the first embodiment) and C size Alkaline Secondary Battery C4 (structure of the third embodiment) were formed and evaluated in a manner similar to that of the AA size batteries described above. The result of the evaluation is shown in Table 4.

TABLE 4

| | | | Result of Evaluation | | |
|---|---|---|---|---|---|
| | | | The Number of | The Number of | |
| | | | Batteries | Batteries in | |
| | | | in which | which Leakage | The Number |
| Battery | | | CIDs Operated | Occurred | of Ruptured |
| | P1 | P2 | within 4 Cycles | within 4 Days | Batteries |
| | [MPa] | [MPa] | in Test (1) | in Test (2) | in Test (3) |
| A28 | 0.5 | 2.0 | 2 | 0 | 0 |
| A29 | | 3.0 | 3 | 0 | 0 |
| A30 | | 4.0 | 2 | 0 | 1 |
| A31 | 1.0 | 2.0 | 0 | 0 | 0 |
| A32 | | 3.0 | 0 | 0 | 0 |
| A33 | | 4.0 | 0 | 0 | 2 |
| A34 | 1.5 | 2.0 | 0 | 2 | 0 |
| A35 | | 3.0 | 0 | 0 | 0 |
| A36 | | 4.0 | 0 | 0 | 1 |
| C4 | 1.0 | 2.0 | 0 | 0 | 0 |

It can be seen that it is preferable in the C size alkaline secondary batteries that P1≧1.0 MPa, P2−P1≧1.0 MPa, and P2≦3.0 MPa.

### Third Example

Alkaline Secondary Batteries A37-A41 (structure of the first embodiment) and Alkaline Secondary Batteries B2-B6 (structure of the second embodiment) were formed by varying the thicknesses of the first connection member and the second connection member of Alkaline Secondary Battery A0 and the thickness of the first connection member of Alkaline Secondary Battery B0 of the first example, and were evaluated.

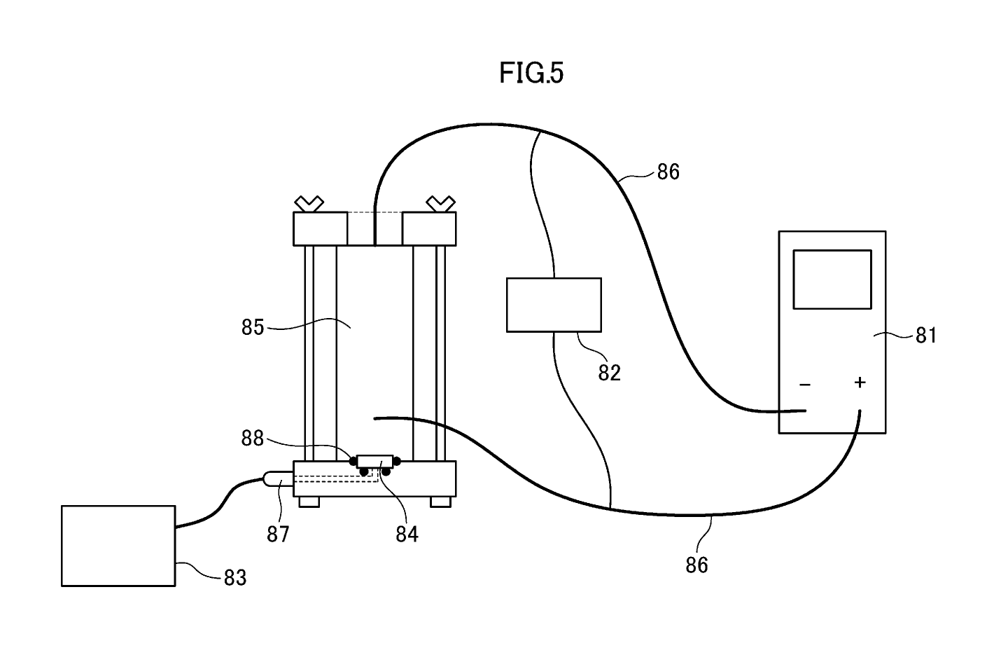

The evaluation was performed in such a manner that battery internal pressure was measured by using a device as illustrated in FIG. 5. First, a hole having a diameter of about 2 mm was formed by an electric drill to form an opening at the center of a positive electrode terminal of a battery 85, and the opening was covered with packing 84 and hermetically sealed with an O-ring 88. Leads 86, 86 were connected to a positive electrode (battery case) and a negative electrode terminal of the battery 85, and the battery 85 was charged by a direct-current power supply 81. Here, overcharge was caused to intentionally generate gas in the battery 85. Battery internal pressure was measured by using a pressure sensor 87 via the packing 84, and the battery internal pressure was displayed on a pressure monitor 83. Moreover, a battery voltage was measured by a voltage monitor 82. Eight batteries for each specification were evaluated, and a variation (standard deviation) in battery internal pressure of the time at which the current cut-off mechanisms (CIDs) operated was computed. The result of the evaluation is shown in Table 5.

TABLE 5

| | Thickness of | Standard Deviation of |
|---|---|---|
| | Connection Member | Pressure at which |
| Battery | [mm] | CID operated [MPa] |
| A37 | 0.08 | 0.50 |
| A38 | 0.1 | 0.28 |
| A39 | 0.3 | 0.28 |
| A40 | 0.7 | 0.30 |
| A41 | 0.8 | 0.45 |
| B2 | 0.08 | 0.45 |
| B3 | 0.1 | 0.26 |
| B4 | 0.3 | 0.27 |
| B5 | 0.7 | 0.29 |
| B6 | 0.8 | 0.40 |

Taking variations in actual manufacturing processes into consideration, the standard deviation in battery internal pressure of the time at which the current cut-off mechanisms operates is preferably 0.3 MPa or lower. When the first connection member and the second connection member made of thin plates each have a thickness of 0.08 mm, the members may deform in being inserted into the sealing body due to their small thickness, which may lower the accuracy of the insertion. This widely varies the battery internal pressure of the time at which the current cut-off mechanism operates, and the battery internal pressure goes out of a preferable range. When the thickness is 0.1 mm, the variation in battery internal pressure is within the preferable range.

In contrast, when the thickness is large, specifically, when the thickness is 0.8 mm, a load is not successfully applied to the engraved portion or the second connection member made of metal foil even when the battery internal pressure increases. As a result, the battery internal pressure of the time at which the current cut-off mechanism operates widely varies, and goes out of the preferable range. When the thickness is 0.7 mm, the variation in battery internal pressure is within the preferable range. From the foregoing, the first connection member and the second connection member each preferably have a thickness of greater than or equal to 0.1 mm and less than or equal to 0.7 mm.

### Fourth Example

A water repellant was applied to a lower surface of the second connection member 30 of Battery A0 of the first example (a side facing the negative electrode 3), thereby forming an alkaline secondary battery. This alkaline secondary battery is referred to as Battery E1.

Alkaline Secondary Batteries A0, E1, 10 each, were assembled, and stored at 60° C. and at a humidity of 90% for three months without being discharged. After the period of the storage had elapsed, the batteries were inspected for leakage. The result is shown in Table 6.

TABLE 6

| | The Number of Batteries in |
|---|---|
| Battery | which Leakage Occurred |
| E1 | 0 |
| A0 | 2 |

Since an alkaline electrolyte solution adheres to a surface of the second connection member which faces the negative electrode, applying an water repellant to at least part of the surface prevents creep of the alkaline electrolyte solution caused by an electrocapillary phenomena, so that release of the alkaline electrolyte solution to the outside of the battery can be prevented. Thus, in Battery E1, no leakage due to the creep occurs even in a high-temperature, high-humidity environment.

In Battery A0 without the water repellant, leakage occurred in two of the ten batteries. The resistance between the positive electrode terminal and the negative electrode terminal of each battery in which leakage occurred was measured, and it was found that the current cut-off mechanism had not operated. Thus, it turned out that the leakage was caused due to the creep of the alkaline electrolyte solution.

Note that the advantages described above are obtained as long as the water repellant is applied at least to a crimped part on an outer peripheral side of the lower surface of the second connection member 30, and to an exposed part continuous from the crimped part.

### Fifth Example

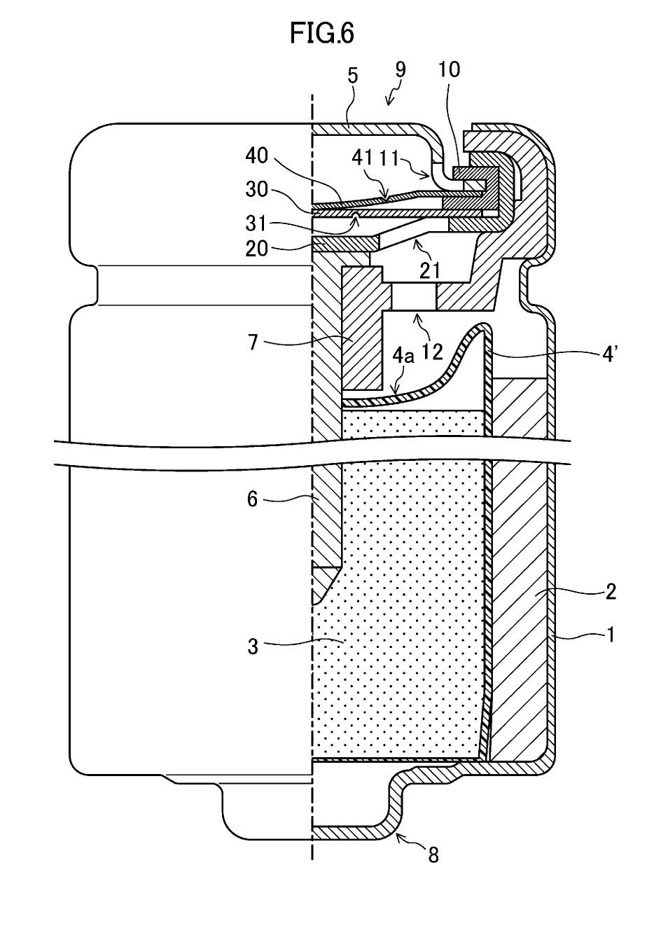

As illustrated in FIG. 6, in Battery A0 of the first example, a separator 4′ which is longer (52 mm) than the usual length (49 mm) was prepared. A portion of the separator 4′ protruding above the negative electrode 3 was bent in a direction toward the center axis, thereby forming a lid portion 4a over the negative electrode 3. In this way, Battery F1 was formed in which the second connection member 30 and the negative electrode 3 were isolated from each other by the lid portion 4a (nonwoven fabric and cellophane).

Alkaline Secondary Batteries A0, F1, 10 each, were repeatedly discharged, charged, and stored under the same conditions as those of the first example to allow operation of the current cut-off mechanisms of all the batteries. Then, the batteries were vibrated in a forced manner, and then resistance measurement between the positive electrode terminal and the negative electrode terminal of each battery was performed. The number of batteries in which the resistance value was obtained by the measurement is shown in Table 7.

TABLE 7

| | The Number of Batteries in |
|---|---|
| Battery | which Conduction Occurred |
| F1 | 0 |
| A0 | 1 |

When Alkaline Secondary Battery A0 without the lid portions 4a is vibrated, zinc alloy powder of the negative electrode 3 wafts to the second connection member 30 even when the current cut-off mechanism operates, which may establish conduction between the first connection member 40 and the second connection member 30 again. For this reason, there was a battery in which the resistance value between the positive electrode terminal and the negative electrode terminal was measurable. In this case, a battery in which the current cut-off mechanism has operated, and thus should be normally unusable has the possibility of being useable. If the battery in this state is continuously used, leakage may occur in an electronic device, which is not preferable.

In contrast, when the lid portion 4a made of nonwoven fabric isolates the negative electrode 3 from the second connection member 30, the lid portion 4a inhibits wafting of zinc alloy powder toward the second connection member 30, so that the above-described problem does not arise.

### Sixth Example

Metatitanic acid was added to a positive electrode, and the effect thereof was examined. It was provided that Alkaline Secondary Battery A0 of the first example was Battery D1 to which metatitanic acid was not added. To the positive electrode of Battery A0, 0.1% by mass of metatitanic acid with respect to electrolytic manganese dioxide was added to form Battery G1, 3.0% by mass of metatitanic acid with respect to electrolytic manganese dioxide was added to form Battery G2, and 4.0% by mass of metatitanic acid with respect to electrolytic manganese dioxide was added to form Battery G3.

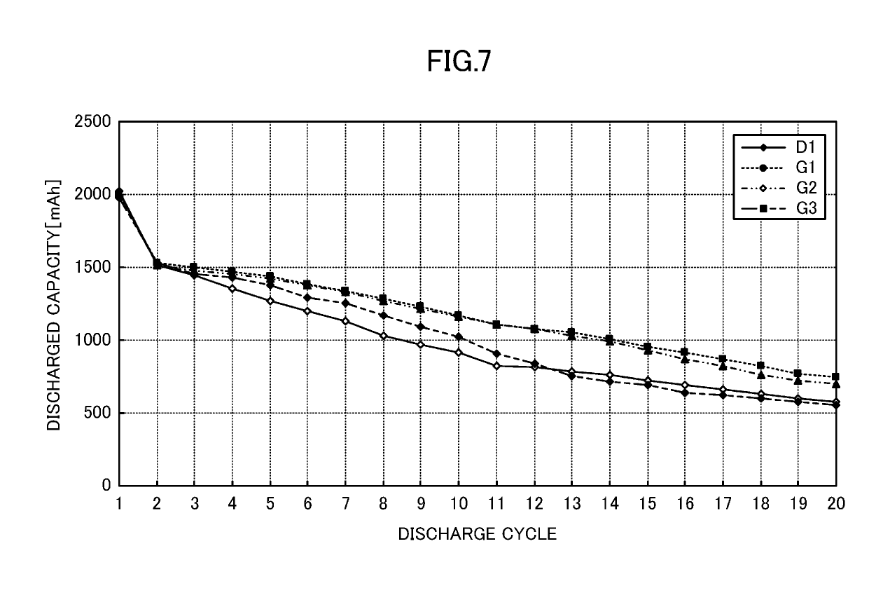

Cycles of discharge, charge, and storage as those in the first example were performed. Discharge capacity in each cycle is shown in FIG. 7. Batteries G1, G2 have preferable cycle characteristics that the discharge capacity is large compared to that of Battery D1 even when the number of cycles is increased. However, the discharge capacity of Battery G3 was comparable to or smaller than that of Battery D1 probably because the absolute quantity of the electrolytic manganese dioxide is reduced.

Thus, this is preferable because when metatitanic acid is added to the positive electrode in the mass ratio of 0.1% to 3.0%, both inclusive relative to manganese dioxide, degradation in reversibility of oxidation/reduction of manganese dioxide along with an increasing number of cycles can be reduced, and the discharge capacity can be maintained.

### Seventh Example

A suitable value of the ratio between theoretical capacities of the positive electrode and the negative electrode was studied.

For the study, Alkaline Secondary Battery G1 of the sixth example (0.1% by mass of metatitanic acid was added) was used as a base to form Batteries H1-H4 each having a negative electrode theoretical capacity/positive electrode theoretical capacity ratio as shown in Table 8.

TABLE 8

| | | | | The Number of |
|---|---|---|---|---|
| | | | | Batteries Having a |
| | Manganese | Zinc | −/+Theoretical | Discharged Capacity |
| | Dioxide | Weight | Capacity | of less than 1300 |
| Battery | Weight [g] | [g] | Ratio | mAh at the 5th Cycle |
| H1 | 8.0 | 3.0 | 1.00 | 6 |
| H2 | 8.0 | 3.3 | 1.10 | 0 |
| H3 | 8.0 | 3.9 | 1.30 | 0 |
| H4 | 8.0 | 4.2 | 1.40 | 2 |

Generally, in order to oxidize and reduce manganese dioxide within one electron reaction having reversibility, alkaline secondary batteries have to be designed to have a low negative electrode theoretical capacity/positive electrode theoretical capacity ratio (less than 1.10). However, as illustrated in Table 8, the effect of adding metatitanic acid provides a large discharge capacity when the ratio has a value of 1.10 to 1.30, both inclusive. That is, a large amount of the negative electrode active material can be put in the battery, and the discharge capacity can be increased.

### Eighth Example

In an AA size alkaline secondary battery, suitable values (balance) of the volume of space, the amount of a positive electrode active material, the amount of a negative electrode active material, and the amount of an alkaline electrolyte solution were studied.

Batteries I1-I9 each having the same configuration as that of Alkaline Secondary Battery A0 of the first example were formed, where the above-described four amounts of Batteries I1-I9 were shown in Table 9. These batteries, ten each, were subjected to cycles of discharge, charge, and storage which were repeatedly performed under the same conditions as those of the first example.

TABLE 9

| | | | | | | The Number |
|---|---|---|---|---|---|---|
| | | | | | | of Batteries |
| | | | | Total | The Number | having a |
| | | | | Amount of | of Batteries in | Discharged |
| | Volume of | | | Alkaline | which CIDs | Capacity of |
| | Space in | Manganese | Zinc | Electrolyte | Operated | less than |
| | Battery | Dioxide | Weight | Solution | within 9 | 1300 mAh at |
| Battery | [mL] | Weight [g] | [g] | [g] | Cycles | the 5th Cycle |
| I1 | 6.00 | 8.0 | 3.0 | 3.5 | 3 | 0 |
| I2 | 6.15 | 7.8 | 3.0 | 3.5 | 0 | 7 |
| I3 | 6.15 | 8.0 | 2.8 | 3.5 | 0 | 4 |
| I4 | 6.15 | 8.0 | 3.0 | 3.3 | 0 | 4 |
| I5 | 6.15 | 8.0 | 3.0 | 3.5 | 0 | 0 |
| I6 | 6.15 | 9.0 | 4.2 | 4.0 | 3 | 0 |
| I7 | 6.15 | 9.0 | 4.0 | 4.2 | 2 | 0 |
| I8 | 6.15 | 9.0 | 4.0 | 4.0 | 0 | 0 |
| I9 | 6.15 | 8.5 | 3.5 | 3.7 | 0 | 0 |

In an AA size alkaline secondary battery which has a high discharge capacity even when charge/discharge are performed a plurality of times (determined based on the discharge capacity of the fifth cycle), and which can be charged/discharged a large number of times (determined based on that the current cut-off mechanism does not operate until the tenth cycle), the volume of space in the battery is 6.15 ml or larger, manganese dioxide is greater than or equal to 8.0 g and less than or equal to 9.0 g, zinc is greater than or equal to 3.0 g and less than or equal to 4.0 g, and the total amount of the alkaline electrolyte solution is greater than or equal to 3.5 g and less than or equal to 4.0 g. Such an AA size alkaline secondary battery can have both a large amount of an active material and sufficient space for accumulating gas.

### Other Embodiments

The above-described embodiments and examples of the present invention are provided merely for the illustration purpose, and do not limit the present invention. The electrolyte concentration, the specific surface area of the zinc of the negative electrode, the zinc alloy composition, etc. illustrated in the examples are also provided merely for the illustration purpose, and are not limited to those values, etc. As the negative electrode, a hydrogen-absorbing alloy, or metal magnesium may be used. Alternatively, when zinc or a zinc alloy is used as the negative electrode active material, a porous zinc body or the like may be used instead of the gelled negative electrode. As the positive electrode active material, nickel oxyhydroxide, silver oxide, etc. may be used.

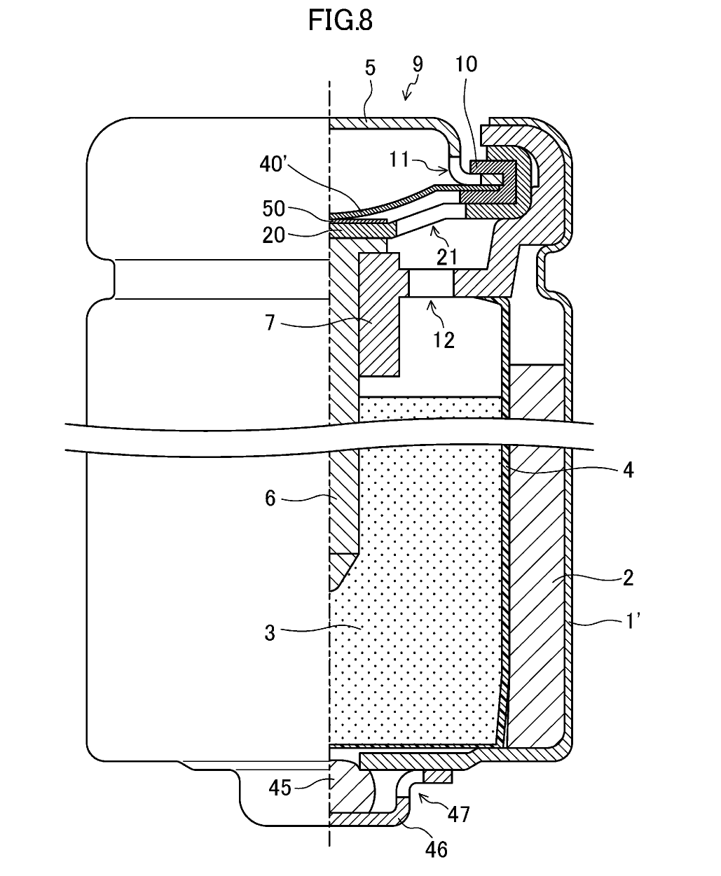

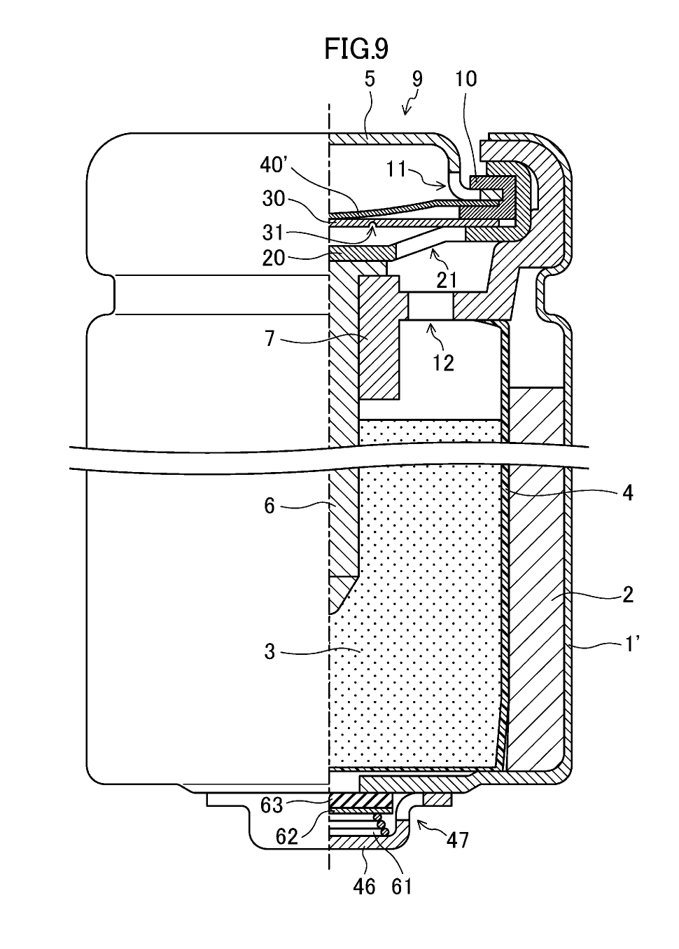

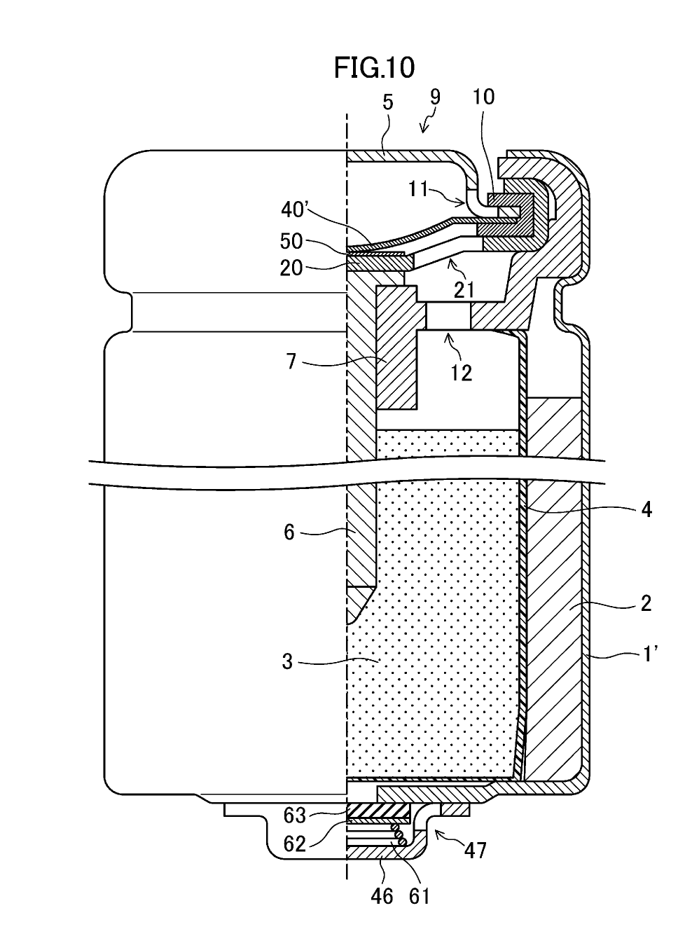

Alternatively, as illustrated in FIG. 8, an alkaline secondary battery may have a current cut-off mechanism having the configuration of the second embodiment, and a communicative connection mechanism having the configuration of the third embodiment. Note that here, the first connection member 40′ does not have a thin portion. Alternatively, as illustrated in FIG. 9, an alkaline secondary battery may have a current cut-off mechanism having the configuration of the third embodiment, and a communicative connection mechanism which is a return-type spring valve body instead of the rubber valve body. The spring valve body includes a plate-like valve portion which closes a hole in the bottom of the battery case 1′ and a coiled spring 61 which serves as a pressing member to press the valve body to the body case V. The valve portion includes an elastic body portion 63 arranged on a side close to the hole of the battery case 1′ and a steel sheet portion 62 arranged on a side close to the coiled spring 61. Alternatively, as illustrated in FIG. 10, an alkaline secondary battery may have a current cut-off mechanism having the configuration of the second embodiment, and a communicative connection mechanism having a return-type spring valve body which is the same as that of FIG. 9.

The first connection member and the second connection member are not limited to such a configuration that is ruptured at the engraved portion and the thin portion. These members may be configured to have an engaging structure or a fitting structure, and engagement or fitting may be released due to increasing internal pressure.

The water repellant may also be applied at least a part of lower surface of the first connection member and the electrical conduction mediating member. The part to which the water repellant is applied is preferably an outer peripheral portion similar to the case of the second connection member.

### INDUSTRIAL APPLICABILITY

As described above, the alkaline secondary battery of the present invention cuts off conduction in the battery when battery internal pressure increases so that the battery can no longer be charged/discharged, and thus serves as a secondary battery having a high leakage resistance, and is useful for power sources of electronic devices, toys, etc.

### DESCRIPTION OF REFERENCE CHARACTERS

1, 1′ Battery Case
2 Positive Electrode
3 Negative Electrode
4, 4′ Separator
5 Negative Electrode Terminal Plate
6 Negative Electrode Current Collector
7 Sealing Resin Member
8 Positive Electrode Terminal
9 Negative Electrode Terminal
10 Pressing Member
11 Through Hole
20 Electrical Conduction Mediating Member
30 Second Connection Member
31 Engraved Portion
40, 40′ First Connection Member
41 Thin Portion
45 Rubber Valve Body
47 Through Hole
50 Second Connection Member
61 Coiled Spring
62 Steel Sheet Portion of Valve Member
63 Elastic Body Portion of Valve Member

1. An alkaline secondary battery comprising:
a cylindrical battery case which has a closed end and is provided with a positive electrode terminal;
a cylindrical positive electrode accommodated in the cylindrical battery case;
a negative electrode arranged in a hollow portion of the positive electrode;
a separator arranged between the positive electrode and the negative electrode; and
an alkaline electrolyte solution accommodated in the cylindrical battery case, wherein
a sealing body provided with a negative electrode terminal hermetically seals an opening of the battery case, and
the sealing body has a current cut-off mechanism configured to cut off current conduction between the negative electrode and the negative electrode terminal when internal pressure reaches a predetermined pressure P1.

2. The alkaline secondary battery of claim 1, wherein
a negative electrode current collector configured to supply a current to the negative electrode terminal is arranged in the negative electrode,
the current cut-off mechanism includes a first connection member which is made of metal and is electrically connected to the negative electrode terminal, and a second connection member which is made of metal and is electrically connected to the negative electrode current collector,
the first connection member is electrically connected to the second connection member, and
when the internal pressure reaches the predetermined pressure P1, the second connection member is ruptured by the internal pressure to cut off current conduction between the negative electrode current collector and the negative electrode terminal.

3. The alkaline secondary battery of claim 2, wherein
the negative electrode contains zinc or a zinc alloy as a main active material, and
the first connection member and the second connection member are made of copper or an alloy containing copper as a main component.

4. The alkaline secondary battery of claim 3, further comprising:
a communicative connection mechanism configured to bring space in the battery into communication with space outside the battery when the internal pressure reaches a predetermined pressure P2, where P1<P2.

5. The alkaline secondary battery of claim 4, wherein
the alkaline secondary battery is an AA size alkaline secondary battery, and
the predetermined pressures P1 [MPa] and P2 [MPa] satisfy the relational expressions: 2.0≦P1, P2≦8.0, and P2−P1≧3.5.

6. The alkaline secondary battery of claim 4, wherein
the alkaline secondary battery is an AAA size alkaline secondary battery, and
the predetermined pressures P1 [MPa] and P2 [MPa] satisfy the relational expressions: 3.0≦P1, P2≦11.0, and P2−P1≧6.0.

7. The alkaline secondary battery of claim 4, wherein
the alkaline secondary battery is a D size alkaline secondary battery, and
the predetermined pressures P1 [MPa] and P2 [MPa] satisfy the relational expressions: 0.5≦P1, P2≦2.0, and P2−P1≧1.0.

8. The alkaline secondary battery of claim 4, wherein
the alkaline secondary battery is a C size alkaline dry battery, and
the predetermined pressures P1 [MPa] and P2 [MPa] satisfy the relational expressions: 1.0≦P1, P2≦3.0, and P2−P1≧1.0.

9. The alkaline secondary battery of claim 4, wherein
the first connection member includes a thin portion having a smaller thickness than a portion around the thin portion, and
the communicative connection mechanism is operated by rupturing the thin portion by the internal pressure.

10. The alkaline secondary battery of claim 4, wherein
the positive electrode terminal includes a return-type rubber valve body or a spring valve body, and
the communicative connection mechanism is operated by operation of the rubber valve body or the spring valve body.

11. The alkaline secondary battery of claim 4, wherein
the second connection member has a thickness of 0.1 mm to 0.7 mm, both inclusive.

12. The alkaline secondary battery of claim 4, wherein
a water repellant is applied to at least part of surfaces of the first connection member, the second connection member, or an electrical conduction mediating member which face the negative electrode.

13. The alkaline secondary battery of claim 4, wherein
the negative electrode is a gelled zinc negative electrode obtained by dispersing zinc particles or zinc alloy particles into a gelled alkaline electrolyte solution.

14. The alkaline secondary battery of claim 13, wherein
nonwoven fabric is provided between the negative electrode and the second connection member to insulate the negative electrode from the second connection member.

15. The alkaline secondary battery of claim 13, wherein
the positive electrode contains manganese dioxide as a main active material.

16. The alkaline secondary battery of claim 15, wherein
metatitanic acid is added to the positive electrode in a mass ratio of 0.1% to 3%, both inclusive relative to the manganese dioxide.

17. The alkaline secondary battery of claim 16, wherein
when the manganese dioxide has a theoretical capacity of 308 mAh/g, and the zinc has a theoretical capacity of 819 mAh/g, a value of negative electrode theoretical capacity/positive electrode theoretical capacity is greater than or equal to 1.10 and less than or equal to 1.30.

18. The alkaline secondary battery of claim 17, wherein
the alkaline secondary battery is an AA size alkaline secondary battery,
a volume of space in the battery formed when the battery case is sealed with the sealing body is larger than 6.15 mL,
a weight of the manganese dioxide contained in the positive electrode is greater than or equal to 8.0 g and less than or equal to 9.0 g,
a weight of the zinc contained in the negative electrode is greater than or equal to 3.0 g and less than or equal to 4.0 g, and
a total amount of the alkaline electrolyte solution is greater than or equal to 3.5 g and less than or equal to 4.0 g.
